(19) United States
(12) Patent Application Publication
(10) Pub. No.: US 2019/0059644 A1
(43) Pub. Date: Feb. 28, 2019

(54) GRILL CONVEYOR STAGING SYSTEM

(71) Applicant: Taylor Commercial Foodservice Inc., Rockton, IL (US)

(72) Inventors: Dennis J. Nelson, Rockford, IL (US); Jeffrey L. Sands, Freeport, IL (US); James J. Minard, Rockford, IL (US); Alex Zivkovic, Rockford, IL (US)

(73) Assignee: Taylor Commercial Foodservice Inc., Rockton, IL (US)

(21) Appl. No.: 16/108,638

(22) Filed: Aug. 22, 2018

Related U.S. Application Data
(60) Provisional application No. 62/550,247, filed on Aug. 25, 2017.

(51) Int. Cl. A47J 37/04; A47J 36/32

(52) U.S. Cl. CPC A47J 37/045; A47J 37/044; A47J 36/32

(57) ABSTRACT

A staging system is provided. The staging system includes a movable belt and a heating member. The movable belt includes first and second ends. The movable belt supports and transports products by receiving the products at the first end and outputting the products from the second end to an expired product area. The heating member provides a heat source to the products while the products are supported and transported by the movable belt. Additionally, the staging system comprises a controller. The controller operates the movable belt to transport each of the products between the first end and the second end in accordance with an expiration timer.

### RELATED APPLICATION

The present patent document claims the benefit of the filing date under 35 U.S.C. § 119(e) of Provisional U.S. Patent Application Ser. No. 62/550,247, filed Aug. 25, 2017, which is hereby incorporated by reference.

### BACKGROUND

The subject matter disclosed herein generally relates to restaurants and food preparation establishments and, more particularly, to scheduling for food preparation at restaurants and food preparation establishments.

Often the demand for food products to be prepared in a restaurant is variable and sporadic, particularly at fast-food or other eat-in or take-out dining establishments. For example, preparation of grilled foods in particular may be of such variability that waste and/or time delays may result due to variable states of demand and preparation. Such variability can lead to personnel of a restaurant cooking and/or preparing more food product than is required, which can result in waste, or not cooking enough product resulting in long customer wait times. The waste issue may arise due to mandatory limits or restrictions on how long a food product can be left waiting for a customer (e.g., time from being cooked to time of serving). Such issues are further complicated by having customers arrive in large groups, on busses or queuing up at a drive-through, which can cause visibility issues related to incoming demand for the personnel inside the restaurant

### BRIEF DESCRIPTION

In accordance with one or more embodiments, a staging system is provided. The staging system comprises a movable belt comprising first and second ends and configured to support and transport one or more products by receiving the one or more products at the first end and outputting the one or more products from the second end to an expired product area; a heating member providing a heat source to the one or more products while the one or more products are supported and transported by the movable belt; and a controller configured to operate the movable belt to transport each of the one or more products between the first end and the second end in accordance with an expiration timer.

In accordance with one or more embodiment or the staging system embodiment above, the controller can logically associate individual instances of the expiration timer with each of the one or more products when that product is received by the movable belt at the first end.

In accordance with one or more embodiment or any of the staging system embodiments above, the expiration timer can comprise a counter that operates for a predefined time period that concludes at a moment when a product is no longer usable.

In accordance with one or more embodiment or any of the staging system embodiments above, upon receipt of a first product of the one or more products at the first end, the controller can advance the movable belt in synchronization with the expiration timer to output the first product from the second end to the expired product area at the conclusion of the expiration timer.

In accordance with one or more embodiment or any of the staging system embodiments above, the synchronization can comprise the controller indexing the one or more products in accordance with the expiration timer.

In accordance with one or more embodiment or any of the staging system embodiments above, the synchronization can comprise the controller continuously moving the one or more products in accordance with the expiration timer.

In accordance with one or more embodiment or any of the staging system embodiments above, the staging system can comprise a sensor for detecting each product of the one or more products as it is received at the first end of the movable belt.

In accordance with one or more embodiment or any of the staging system embodiments above, the staging system can comprise a sensor for detecting each product of the one or more products as it is discarded at the second end of the movable belt to the expired product area.

In accordance with one or more embodiment or any of the staging system embodiments above, the staging system can comprise a plurality of movable belts, including the movable belt, each of which supports and transports the one or more products; and a plurality of heating members, including the heating member, each of which being associated with one of the plurality of movable belts and providing a heat source to the one or more products supported and transported by the associated one of the plurality of movable belts.

In accordance with one or more embodiment or any of the staging system embodiments above, the heating member can comprise a flat cooking grill that provides the heat source to the one or more products while the one or more products are supported and transported by the movable belt.

In accordance with one or more embodiment or any of the staging system embodiments above, the movable belt can be removable from the staging system to expose the flat cooking grill for direct cooking.

In accordance with one or more embodiment or any of the staging system embodiments above, the controller can provide a notification with respect to when the one or more products are received at the first end or when the one or more products are outputted from the second end to the expired product area.

In accordance with one or more embodiment, a staging system is provided. The staging system comprises a movable belt providing one or more cooked food products for a predefined time period; a heating member providing a heat source to the one or more cooked products during the predefined time period; and a controller operating the movable belt to transport each of the one or more cooked products with the movable belt and operating the movable belt to discard the one or more cooked food products at a conclusion of the predefined time period.

In accordance with one or more embodiment or the staging system embodiment above, wherein the controller logically associates individual instances of the predefined time period with each of the one or more cooked food products when that product is received by the movable belt.

In accordance with one or more embodiment or any of the staging system embodiments above, the controller can comprise a counter that operates for the predefined time period that concludes at a moment when a product of the one or more cooked food products is no longer usable.

In accordance with one or more embodiment or any of the staging system embodiments above, upon receipt of a first product of the one or more cooked food products at a first end of the movable belt, the controller can advance the movable belt in synchronization with the predefined time period to discard the first product from a second end of the movable belt.

In accordance with one or more embodiment or any of the staging system embodiments above, the staging system can comprise a sensor for detecting each product of the one or more cooked food products as it is received from a cooking area.

In accordance with one or more embodiment or any of the staging system embodiments above, the staging system can comprise a sensor for detecting each product of the one or more cooked food products as it is discarded.

In accordance with one or more embodiment or any of the staging system embodiments above, the staging system can comprise: a plurality of movable belts, including the movable belt, each of which supports and transports the one or more cooked food products; and a plurality of heating members, including the heating member, each of which being associated with one of the plurality of movable belts and providing a heat source to the one or more cooked food products.

In accordance with one or more embodiment or any of the staging system embodiments above, the heating member can comprise a flat cooking grill that provides the heat source to the one or more cooked food products while the one or more cooked food products are provided by the movable belt.

### BRIEF DESCRIPTION OF THE DRAWINGS

The following descriptions should not be considered limiting in any way. With reference to the accompanying drawings, like elements are numbered alike:

FIG. 1 depicts an automated cook conveyor comprising a grill conveyor staging system in accordance with one or more embodiments;

FIG. 2 is a conveyor assembly of a grill conveyor staging system of FIG. 1 in accordance with one or more embodiments;

FIG. 3 is a grill conveyor staging system comprising two flat cooking grills in accordance with one or more embodiments;

FIG. 4 is a grill conveyor staging system in accordance with one or more embodiments; and

FIG. 5 is a series of conveyor assemblies of a grill conveyor staging system in accordance with one or more embodiments.

### DETAILED DESCRIPTION

A detailed description of one or more embodiments of the disclosed apparatus and method are presented herein by way of exemplification and not limitation with reference to the Figures.

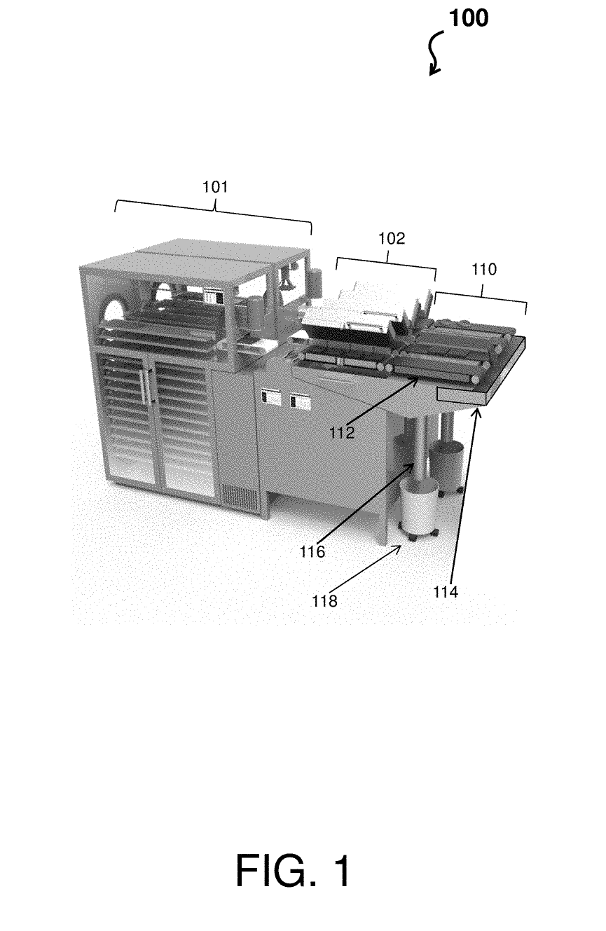

FIG. 1 depicts an automated cook conveyor 100 in accordance with one or more embodiments. The automated cook conveyor 100 is a flexible and automatic cooking system for delivering quality and consistency in cooked food products (generally referred to as products). Examples of products can include, but are not limited to chicken, beef, pork, seafood, and/or vegetarian products. The automated cook conveyor 100 can optimize an amount of products cooked while maintaining food safety, food quality, and throughput. As shown, the automated cook conveyor 100 comprises a storage section 101, a cooking section 102, and a grill conveyor staging system 110.

The storage section 101 is a unit or area of the automated cook conveyor 100 where raw and/or uncooked products are stored, e.g., in a frozen or refrigerated state. The storage section 101 can supply the raw and/or uncooked products to the cooking section 102. The cooking section 102 is a unit or area of the automated cook conveyor 100 where the raw and/or uncooked products are cooked, before being supplied to the grill conveyor staging system 110 as cooked products.

The grill conveyor staging system 110 is a buffer unit or area of the automated cook conveyor 100 where the cooked products are deposited and held for a predetermined amount of time or predefined time period while awaiting use or before being discarded. For example, the grill conveyor staging system 110 can be considered a staging area that is heated, such that even if a product is not used immediately, the product will maintain its temperature so until it is served. In this way, the staging area manages cooked food by presenting the cooked food to a sandwich preparation operator and discarding expired cooked food. The grill conveyor staging system 110 comprises one or more conveyor assemblies 112, an expired product area 114, a grease trough 116, and a grease storage area 118.

The one or more conveyor assemblies 112 can be configured to support and transport the cooked products. Each of the one or more conveyor assemblies 112 can comprise at least a movable belt and a heating member, along with having first and second (opposite) ends. In accordance with one or more embodiments, the grill conveyor staging system 110 can comprise one or more lanes, each of which can comprise one or more conveyor assemblies 112. The movable belt can transport between the first and second ends by indexing the cooked products or continuously moving the cooked products. The heating member can provide a heat source to the cooked products, while they are being supported and transported by the movable belt, to maintain a desired temperature for the cooked products.

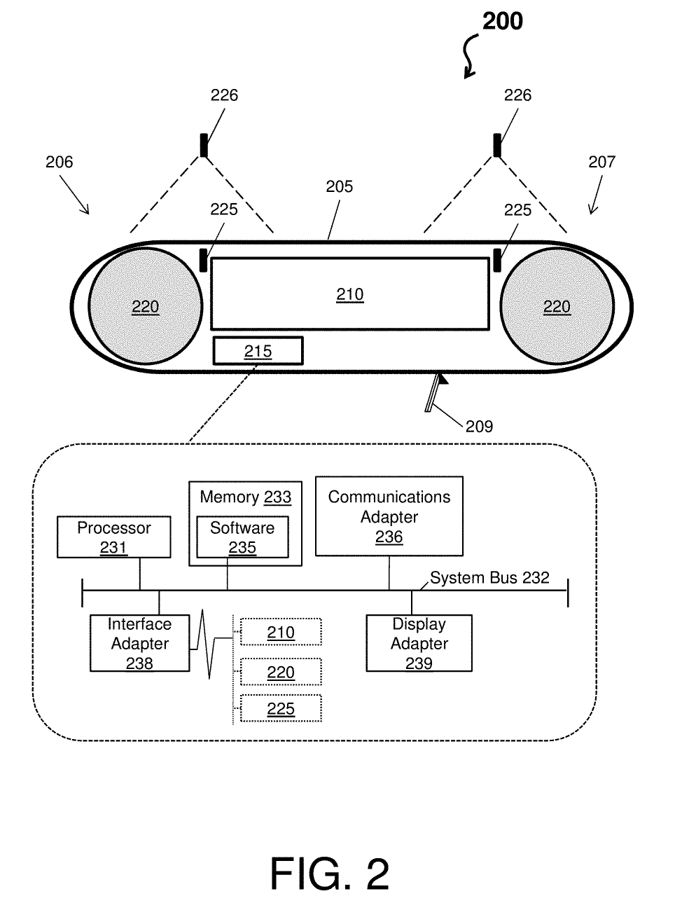

In operation, for example, the cooked products can be received at the first end from the cooking section 102. The moveable belt 205 can support the cooked products above heating member 210 while the cooked products are being transported to the second end. If the cooked products are not used, the moveable belt 205 can output or discard the cooked products from the second end to the expired product area 114. The expired product area 114 can be an expired meat drawer that holds the outputted or discarded food products for alternative use. The expired product area 114 can also a removable bin and/or include slots/holes on the bottom to drain and capture grease. The expired meat drawer can comprise a drainage system for allowing grease from the cooked products to flow downward away from the cooking section 102 and the grill conveyor staging system 110. For instance, the grease from the cooked products can flow downward from the cooking section 102 and the grill conveyor staging system 110 through the grease trough 116 to the grease storage area 118. The grill conveyor staging system 110 and the one or more conveyor assemblies 112 are now further described with respect to FIG. 2.

FIG. 2 is a conveyor assembly 200 of a grill conveyor staging system 110 in accordance with one or more embodiments. The conveyor assembly 200 comprises a (movable) belt 205, a first end 206, a second end 207, a cleaning member 209, a heating member 210, a controller 215, drums 220, and sensors 225, 226. The movable belt 205 can be a carrying medium that rotates about the drums 220 in an endless loop. The cleaning member 209 can be a wiper or similar component that guides grease and/or other residue off the movable belt 205 (e.g., cleans the movable belt 205). One or both of the drums 220 can be powered and controlled by the controller 215 to cause the movable belt 205 to move in a first direction or a second direction (opposite direction to the first). The heating member 210 can be any device used to keep the cooked product from cooling too fast after it enters the staging area. The heating member 210 can comprise a cast-in heater, an induction heater, ceramic disks, metal blocks, steam radiators, a carbon steel plate, a stainless steel plate, an aluminum casting, a ceramic surface, etc. The heating member 210 can also be powered and controlled by the controller 215.

The sensors 225, 226 can be electro-mechanical components that detect events or changes with respect to an environment of the conveyor assembly 200 (or corresponding components therein). Examples of sensors 225 can include, but are not limited to, pressure sensors. Examples of sensors 226 can include, but are not limited to, optical sensors. The sensors 225, 226 can output the events or changes as sensor signals to other components of the conveyor assembly 200 (e.g., the controller 215). The sensors 225, 226 at or near the first end 206 can be for detecting each cooked product as it is received or placed on the movable belt 205. The sensors 225, 226 at or near the second end 207 can be for detecting each cooked product as it is discarded at the second end 207 of the movable belt 205. Note that while multiple sensors 225, 226 are shown, different embodiments can include one or more sensors 225, 226 as required by the grill conveyor staging system 110. For instance, the grill conveyor staging system 110 can include one or more optical sensors 226 that detect the exact position of any cooked product along the movable belt 205. In this regard, the grill conveyor staging system 110 can determine a number of cooked products on the movable belt 205, a location of each cooked product, a location of each cooked product with respect to a predefined time period or an expiration timer, whether an operator has removed a cooked product prior to that cooked product being discarded.

The controller 215 operates at least the movable belt 205 (e.g., via the drums 220) to transport each of the one or more products between the first end 206 and the second end 207 in accordance with an expiration timer. The controller 215 comprises one or more central processing units (CPU(s)) (collectively or generically referred to as a processor 231). The processor 231, also referred to as a processing circuit, is coupled via a system bus 232 to a memory 233 and various other components. The memory 233 can include a read only memory (ROM) and a random access memory (RAM). The ROM can be coupled to the system bus 232 and may include a basic input/output system (BIOS), which controls certain basic functions of the controller 215. The RAM can be read-write memory coupled to the system bus 232 for use by the processor 231. A software 235 for execution on the controller 215 may be stored in the memory 233. In accordance with one or more embodiments, the software 235 can include instructions to implement the expiration timer as a counter that operates for a predefined time period (e.g., set by a user based on the type of cooked product) that concludes at a moment when the cooked product is no longer usable (e.g., a conclusion of the predefined time period). The memory 233 is an example of a tangible storage medium readable by the processor 231, where the software 235 is stored as instructions for execution by the processor 231 to cause the conveyor assembly 200 to operate as described herein. Examples of computer program product and the execution of such instruction is discussed herein in more detail.

The controller 215 can further comprise a communications adapter 236, an interface adapter 238, and a display adapter 239 coupled to the system bus 232. The communications adapter 236 may be a small computer system interface (SCSI) adapter that communicates with a hard disk and/or any other similar component. The communications adapter 236 can interconnect the system bus 232 with a network, which may be an outside network, enabling the conveyor assembly 200 or the grill conveyor staging system 110 to communicate with other systems. The interface adapter 238 can interconnect and integrated multiple devices with the controller 215, such as the heating member 210, the drums 220, and the sensors 225. A display adapter 239 can interconnect a display (e.g., light-emitting diodes, a screen, a display monitor, etc.) to the system bus 232 to provide visual indications of the operations of the grill conveyor staging system 110.

In operation, the conveyor assembly 200 can shift individual instances of cooked product to an operator who removes the individual instances and assembles the sandwiches, meals, etc. The cooked products are timed while on the conveyor assembly 200, such that cooked products are not held over a specified time. Via software, the controller 215 can implement the expiration timer so that expired products can be discarded as desired. For instance, the controller can logically associate individual instances of the expiration timer with each individual instance of cooked product when that product is received by the movable belt 205 at the first end 206. The detection of a cooked product being received by the movable belt 205 can be performed directly by the one or more sensors 225, 226 or by external signals received from another component (e.g., cooking section 102). In this way, upon receipt of a first cooked product at the first end 206, the controller 215 advances the movable belt 205 in synchronization with the expiration timer to output the first product from the second end 207 to the expired product area at the conclusion of the expiration timer (unless the operator removes the cooked product). The synchronization by the controller 215 can include indexing (e.g., moving quickly between positions and holding the cooked product at each position) or continuously moving (e.g., slow moving belt) the cooked products in accordance with the expiration timer. In addition, the controller 215 can provide a notification with respect to when the cooked products are received at the first end 206 or when the cooked products are outputted from the second end 207. Thus, embodiments herein comprise the technical effects and benefits of providing a buffer area sized for hold times and easy preparation access, along with an automatic transfer of expired products.

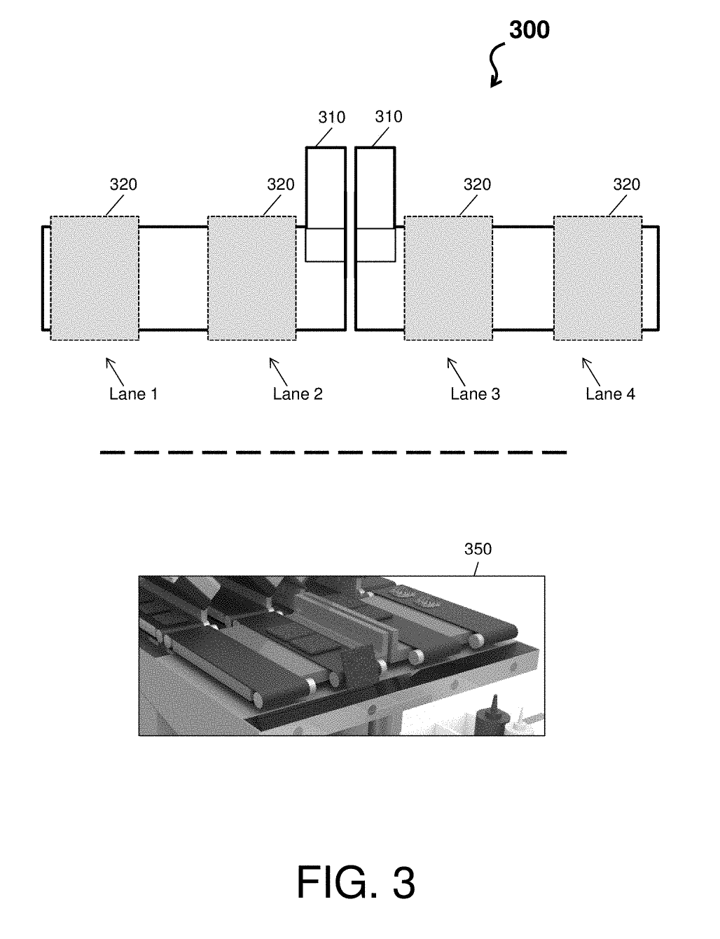

Turning now to FIG. 3, a grill conveyor staging system 300 comprising two flat cooking grills 310 is depicted in accordance with one or more embodiments. Each flat cooking grill 310 that provides the heat source to the cooked products while the cooked products are supported and transported by the conveyor assemblies 320. Note that the grill conveyor staging system 300 is shown with four lanes (e.g., Lane 1, Lane 2, Lane 3, and Lane 4), each of which can comprise one or more conveyor assemblies 320. As shown in example 350 of FIG. 3, the grill conveyor staging system 300 can comprise four lanes, with one conveyor assembly 320 per lane, and two lanes per flat cooking grill 310. The two flat cooking grills 310 are also operational cooking surfaces that can be utilized when the conveyor assemblies 320 have been removed. That is, at least one of the movable belts of the conveyor assemblies 320 and the conveyor assemblies themselves are removable from the grill conveyor staging system 300 to expose the one or both two flat cooking grills 310 for direct cooking. Note that while two conveyor assemblies 320 are shown as paired with each flat cooking grill 310, the conveyor assemblies 320 and/or the flat cooking grill 310 can be sized to render any pairing.

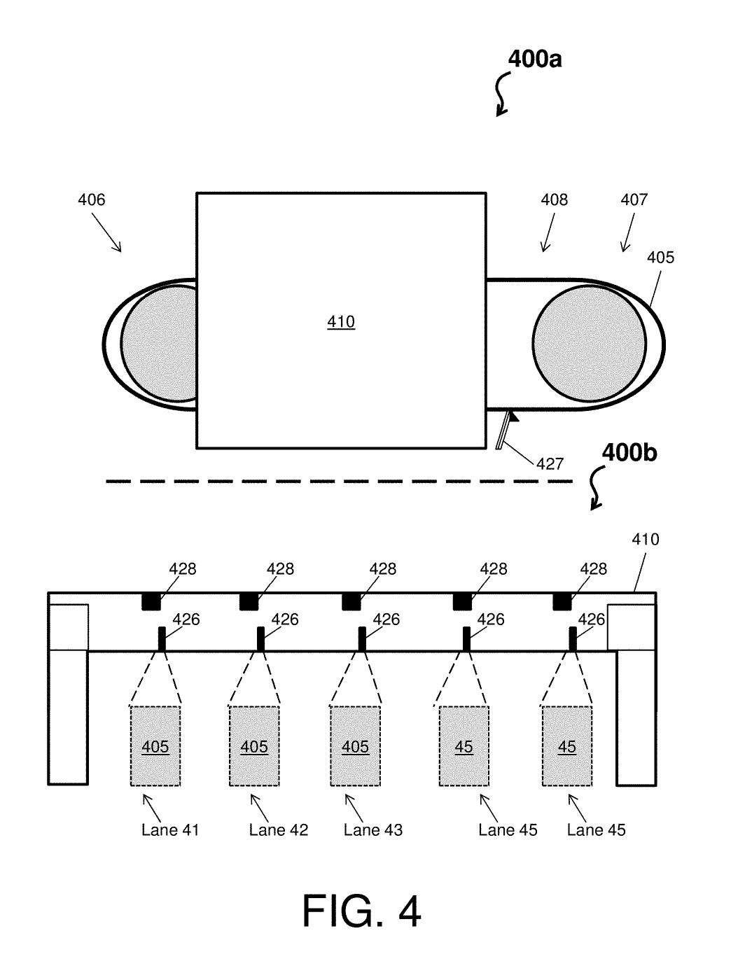

Turning now to FIG. 4, a grill conveyor staging system 400 in accordance with one or more embodiments is shown, with the grill conveyor staging system 400a showing a first view and the grill conveyor staging system 400b showing a second view that is perpendicular to the first view. The grill conveyor staging system 400 comprises one or more lanes (e.g., Lane 41, Lane 42, Lane 43, Lane 44, and Lane 45) that further can comprises one or more conveyor assemblies. Each conveyor assembly can comprise a movable belt 405 that has a first end 406, a second end 407, and a product pick-up area 408, along with an associated cleaning member 427. A heating member 410 can contain and/or surround each lane of grill conveyor staging system 400. In this way, the heating member 410 can maintain an ambient temperature for the environment around the one or more lanes. The heating member 410 can further support and/or comprise one or more sensors 426. The heating member 410 can further support and/or comprise one or more displays 428. Components similar to components of other figures, which have been previously described, are not introduced for ease of explanation. Further, one or more controllers (e.g., controller 215) can be utilized to operate the components of the grill conveyor staging system 400, collectively or individually.

As shown in FIG. 4, the heating member 410 spans a full length of the one or more lanes, but for the product pick-up area 408. In this way, an operator can easily access any cooked products without interacting with the heating member 410. Further, the one or more sensors 426 can determine when a cooked product is awaiting in the product pick-up area 408 and cause the one or more displays 428 to indicate to the operator that the cooked product is ready for access (e.g., a green light illuminating). The one or more displays 428 can also indicate to the operator that a cooked product has recently been discarded due to a corresponding predetermined time period expiring (e.g., a red light illuminating).

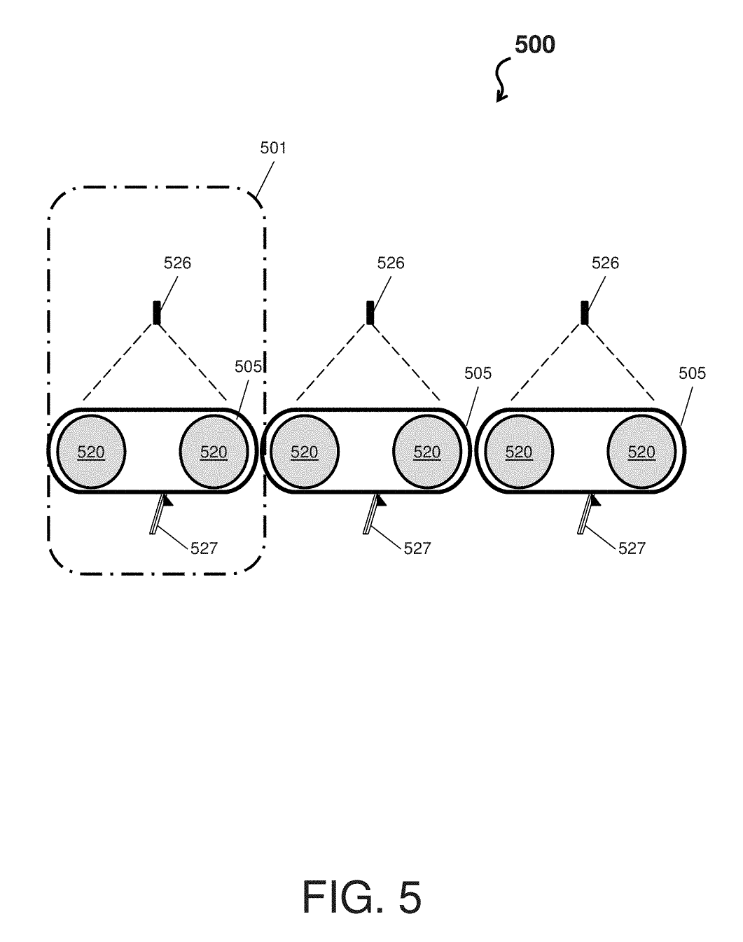

Turning now to FIG. 5, a series of conveyor assemblies 501 of a grill conveyor staging system 500 is shown in accordance with one or more embodiments. Each conveyor assembly 501 can comprise a movable belt 505, a cleaning member 527, drums 520, and a sensor 526. Each conveyor assembly 501 can be sized to support one or more cooked products. As shown in FIG. 5, three conveyor assemblies 501 are aligned in series and can work together to increment one or more cooked products from a cooking section (e.g., the cooking section 102) toward an expired product area (e.g., the area expired product area 114). In an example operation, the sensor 526 associated with each conveyor assemblies 501 can determine that a cooked products is on that corresponding conveyor assembly 501. Thus, if a cooked product is removed from a third conveyor assembly 501 in the series, the grill conveyor staging system 500 can control the first and second conveyor assemblies 501 in the series to index cooked product down the lane.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A staging system comprising:
a movable belt comprising first and second ends and configured to support and transport one or more products by receiving the one or more products at the first end and outputting the one or more products from the second end to an expired product area;
a heating member providing a heat source to the one or more products while the one or more products are supported and transported by the movable belt; and
a controller configured to operate the movable belt to transport each of the one or more products between the first end and the second end in accordance with an expiration timer.

2. The staging system of claim 1, wherein the controller logically associates individual instances of the expiration timer with each of the one or more products when that product is received by the movable belt at the first end.

3. The staging system of claim 1, wherein the expiration timer comprises a counter that operates for a predefined time period that concludes at a moment when a product is no longer usable.

4. The staging system of claim 1, wherein, upon receipt of a first product of the one or more products at the first end, the controller advances the movable belt in synchronization with the expiration timer to output the first product from the second end to the expired product area at the conclusion of the expiration timer.

5. The staging system of claim 4, wherein the synchronization comprises the controller indexing the one or more products in accordance with the expiration timer.

6. The staging system of claim 4, wherein the synchronization comprises the controller continuously moving the one or more products in accordance with the expiration timer.

7. The staging system of claim 1, the staging system comprising a sensor for detecting each product of the one or more products as it is received at the first end of the movable belt.

8. The staging system of claim 1, the staging system comprising a sensor for detecting each product of the one or more products as it is discarded at the second end of the movable belt to the expired product area.

9. The staging system of claim 1, the staging system comprising:
a plurality of movable belts, including the movable belt, each of which supports and transports the one or more products; and
a plurality of heating members, including the heating member, each of which being associated with one of the plurality of movable belts and providing a heat source to the one or more products supported and transported by the associated one of the plurality of movable belts.

10. The staging system of claim 1, wherein the heating member comprises a flat cooking grill that provides the heat source to the one or more products while the one or more products are supported and transported by the movable belt.

11. The staging system of claim 10, wherein the movable belt is removable from the staging system to expose the flat cooking grill for direct cooking.

12. The staging system of claim 1, wherein the controller provides a notification with respect to when the one or more products are received at the first end or when the one or more products are outputted from the second end to the expired product area.

13. A staging system comprising:
a movable belt providing one or more cooked food products for a predefined time period;
a heating member providing a heat source to the one or more cooked products during the predefined time period; and
a controller operating the movable belt to transport each of the one or more cooked products with the movable belt and operating the movable belt to discard the one or more cooked food products at a conclusion of the predefined time period.

14. The staging system of claim 13, wherein the controller logically associates individual instances of the predefined time period with each of the one or more cooked food products when that product is received by the movable belt.

15. The staging system of claim 13, wherein the controller comprises a counter that operates for the predefined time period that concludes at a moment when a product of the one or more cooked food products is no longer usable.

16. The staging system of claim 13, wherein, upon receipt of a first product of the one or more cooked food products at a first end of the movable belt, the controller advances the movable belt in synchronization with the predefined time period to discard the first product from a second end of the movable belt.

17. The staging system of claim 13, the staging system comprising a sensor for detecting each product of the one or more cooked food products as it is received from a cooking area.

18. The staging system of claim 13, the staging system comprising a sensor for detecting each product of the one or more cooked food products as it is discarded.

19. The staging system of claim 13, the staging system comprising:
a plurality of movable belts, including the movable belt, each of which supports and transports the one or more cooked food products; and
a plurality of heating members, including the heating member, each of which being associated with one of the plurality of movable belts and providing a heat source to the one or more cooked food products.

20. The staging system of claim 13, wherein the heating member comprises a flat cooking grill that provides the heat source to the one or more cooked food products while the one or more cooked food products are provided by the movable belt.
